(19) United States
(12) Patent Application Publication
(10) Pub. No.: US 2020/0392775 A1
(43) Pub. Date: Dec. 17, 2020

(54) Structure for Preventing Deviation of Sliding Door

(71) Applicants: Hyundai Motor Company, Seoul (KR); Kia Motors Corporation, Seoul (KR)

(72) Inventor: Hyung-In Yun, Seoul (KR)

(21) Appl. No.: 16/665,839

(22) Filed: Oct. 28, 2019

(30) Foreign Application Priority Data
Jun. 17, 2019 (KR) 10-2019-0071821

(51) Int. Cl. E05D 15/30; E05D 15/10; F16H 19/04

(52) U.S. Cl. CPC E05D 15/30; E05D 15/101; F16H 19/04; B60J 5/06; E05D 2015/1031; E05D 2015/1026; E05Y 2900/531

(57) ABSTRACT

A structure can help to prevent deviation of a sliding door. The structure includes a lower rail mounted in a longitudinal direction of a vehicle body, a slider inserted into and rollably coupled to the lower rail, a swing arm rotatably coupled to the slider and a door of a vehicle, and a lifter having a first end rotatably coupled to the swing arm and a second end rotatably coupled to the door. The lifter is configured to move along with a rectilinear motion or a rotational motion of the swing arm. One end of the swing arm coupled to the door and the other end of the lifter coupled to the door are spaced apart from each other at a predetermined distance and support the door.

### CROSS-REFERENCE TO RELATED APPLICATIONS

This application claims priority to Korean Patent Application No. 10-2019-0071821, filed in the Korean Intellectual Property Office on Jun. 17, 2019, which application is hereby incorporated herein by reference.

### TECHNICAL FIELD

The present invention relates to a structure for preventing deviation of a sliding door.

### BACKGROUND

In general, a vehicle has an occupant compartment having a predetermined size in which a driver or an accompanied occupant may be seated, and occupant compartment opening/closing doors are installed on a vehicle body to open or close the occupant compartment.

Sliding type occupant compartment opening/closing doors include a front sliding door installed at a front side in a longitudinal direction of a vehicle and a rear sliding door installed at a rear side in the longitudinal direction of the vehicle. The front sliding door and the rear sliding door are typically installed to be moved along rails mounted on a vehicle body or the doors.

However, the sliding type occupant compartment opening/closing door in the related art requires three rails (an upper rail, a center rail, and a lower rail) that support an upper portion, a middle portion, and a lower portion of the door during the process of opening or closing the door, and the sliding type occupant compartment opening/closing door also requires components related to the rails. For this reason, the sliding type occupant compartment opening/closing door in the related art has a problem in that the weight of the vehicle and the number of components are increased and a degree of design freedom of the vehicle deteriorates.

Therefore, there has been developed a two-rail type door system for a vehicle provided with only center and lower rails by which a sliding door is slidably supported. For example, Korean Patent No. 10-1684536 (Sliding Door Device for Vehicle) in the related art discloses that a door rail (center rail) is mounted on a sliding door, a vehicle body rail is mounted on a vehicle body, and the sliding door is opened or closed as a center slider coupled to the door rail and a lower slider coupled to the vehicle body rail are moved.

Referring to FIGS. 1 and 2, in the sliding structure in the related art, there are two support points in a vertical direction at which the sliding door is supported, and the support points include a support point A at which the vehicle body rail and the lower slider are connected to each other, and a support point B at which the center rail and the center slider are connected to each other. However, there is a problem in that the sliding door rotates about an imaginary axis X connecting the support points A and B in an L direction (direction of the arrow indicated in FIG. 2) which is a longitudinal direction of the vehicle body.

### SUMMARY

The present invention relates to a structure for preventing deviation of a sliding door. Particular embodiments relate to a structure that has a lifter configured to move along a lower rail in a vehicle mounted with a sliding door and having only center and lower rails, and thus may prevent deviation of the sliding door.

Embodiments of the present invention can provide a new type structure capable of preventing deviation of a sliding door when the sliding door is opened or closed in a vehicle mounted with the sliding door and having only center and lower rails.

An exemplary embodiment of the present invention provides a structure for preventing deviation of a sliding door. The structure includes a lower rail mounted in a longitudinal direction of a vehicle body, a slider inserted into and rollably coupled to the lower rail, a swing arm rotatably coupled to the slider and a door of a vehicle, and a lifter rotatably coupled, at one end thereof, to the swing arm, rotatably coupled, at the other end thereof, to the door. The lifter is configured to move along with a rectilinear motion or a rotational motion of the swing arm, in which one end of the swing arm coupled to the door and the other end of the lifter coupled to the door are spaced apart from each other at a predetermined distance and support the door.

One end of the swing arm may be rotatably coupled to a first mounting bracket fixedly mounted inside the door, and the other end of the lifter may be rotatably coupled to a second mounting bracket fixedly mounted inside the door.

When the swing arm rotates toward the outside of the vehicle, the lifter may rotate to be inclined with respect to the swing arm and apply force toward the outside of the vehicle by using pressure of gas that fills the lifter.

According to the exemplary embodiment of the present invention, the structure may further include a stopper fixedly mounted on the vehicle and at one side of the lower rail and configured to restrict the rectilinear motion or the rotational motion of the swing arm.

The swing arm may have a protruding portion protruding toward the stopper, and the stopper may have a concave portion corresponding to the protruding portion.

According to the exemplary embodiment of the present invention, a load bearing configured to support a load of the door may be coupled to the slider coupled to the lower rail.

The structure may further include a center rail formed at a middle portion of the door, in which support points at which the door is supported include two support points formed on the lower rail and a single support point formed on the center rail.

According to the present invention, the three support points for supporting the sliding door are provided even in the case of the two-rail type sliding door structure having only the center and lower rails, and as a result, the sliding door may be opened or closed without deviating in the L direction.

According to the present invention, since the load bearings are mounted on the slider, the sliding door is prevented from deviating in the H direction (vertical direction of the vehicle body).

### BRIEF DESCRIPTION OF THE DRAWINGS

FIG. 1 is a view illustrating support points at which a sliding door for a vehicle having only center and lower rails in the related art is supported.

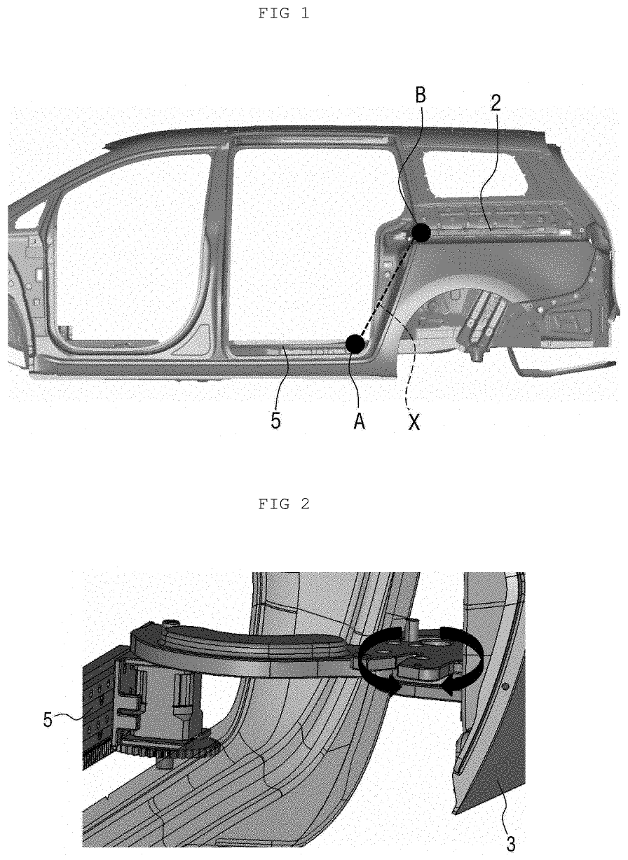

FIG. 2 is a view illustrating a state in which the sliding door illustrated in FIG. 1 is rotatable in an L direction.

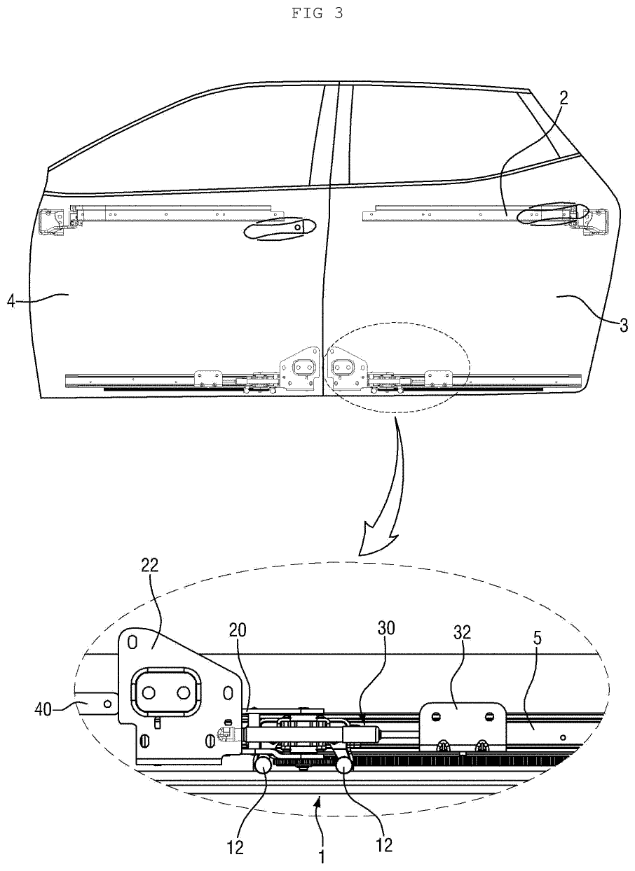

FIG. 3 is a view illustrating a state in which a structure for preventing deviation of a sliding door is provided on each sliding door according to an exemplary embodiment of the present invention.

FIG. 4 is a view illustrating the structure for preventing deviation of a sliding door illustrated in FIG. 3 when viewed from the top side.

FIG. 5 is a view illustrating a state in which a swing arm, to which the structure for preventing deviation of a sliding door is applied, is rotated toward the outside of a vehicle.

FIG. 6A is a view illustrating a state in which a slider is moved along a lower rail in a direction in which a rear door is closed, and FIG. 6B is a view illustrating a state in which the slider is moved along the lower rail in a direction in which the rear door is opened.

FIG. 7A is a view illustrating a point at which a load applied to the rear door is supported in the state illustrated in FIG. 6A, and FIG. 7B is a view illustrating a point at which a load applied to the rear door is supported in the state illustrated in FIG. 6B.

### DETAILED DESCRIPTION OF ILLUSTRATIVE EMBODIMENTS

Hereinafter, exemplary embodiments of a structure for preventing deviation of a sliding door according to the present invention will be described in detail with reference to the drawings. Terms or words used herein should not be interpreted as being limited to a general or dictionary meaning and should be interpreted as a meaning and a concept which conform to the technical spirit of the present invention based on a principle that an inventor can appropriately define a concept of a term in order to describe his/her own invention by the best method.

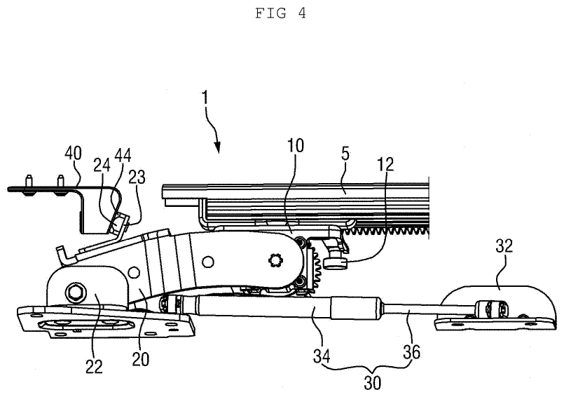

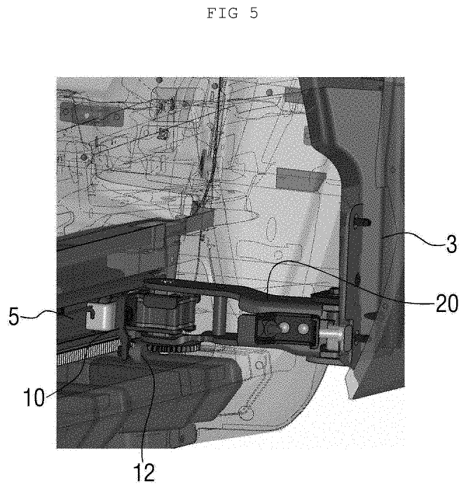

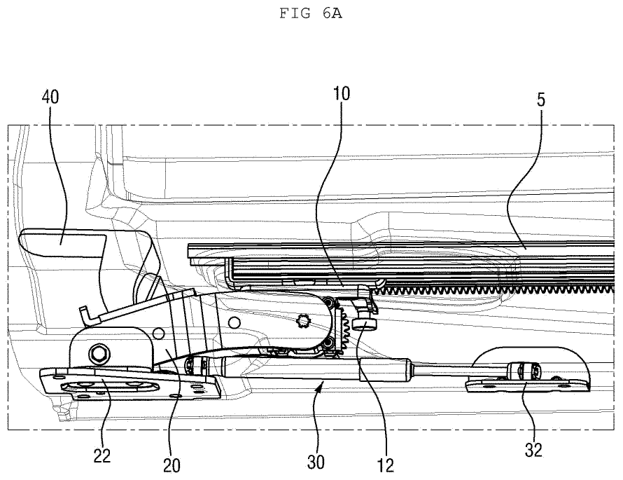

FIG. 3 is a view illustrating a state in which a structure for preventing deviation of a sliding door is provided on each sliding door according to an exemplary embodiment of the present invention, FIG. 4 is a view illustrating the structure for preventing deviation of a sliding door illustrated in FIG. 3 when viewed from the top side, and FIG. 5 is a view illustrating a state in which a swing arm, to which the structure for preventing deviation of a sliding door is applied, is rotated toward the outside of a vehicle.

According to the exemplary embodiment of the present invention, a vehicle has a center rail 2 (a rail disposed at a middle portion of a vehicle) and a lower rail 5 (a rail disposed at a lower portion of the vehicle), but the vehicle has no upper rail (a rail disposed at an upper portion of the vehicle). Here, center rails 2 are provided on sliding doors 3 and 4, respectively, and lower rails 5 are provided on a vehicle body. The sliding doors 3 and 4 include a front door 4 and a rear door 3. A structure 1 for preventing deviation of a sliding door according to the exemplary embodiment of the present invention is applied to the lower rail 5 for the front door 4 or the rear door 3. Therefore, the structures 1 for preventing deviation of a sliding door, which are applied to the front door 4 and the rear door 3, respectively, have the same configuration and the same operational principle, and in the present specification, an example in which the structure 1 for preventing deviation of a sliding door is applied to the rear door 3 will be described for ease of description.

The structure 1 for preventing deviation of a sliding door according to the exemplary embodiment of the present invention includes a slider 10, a swing arm 20, and a lifter 30.

The lower rail 5 is formed in a longitudinal direction of the vehicle body, one end of the slider 10 is inserted into and rollably coupled to the lower rail 5, and the slider 10 moves in the longitudinal direction of the vehicle while being guided by the lower rail 5.

One end of the swing arm 20 is rotatably coupled to a first mounting bracket 22 fixedly mounted inside the rear door 3, and the other end of the swing arm 20 is rotatably coupled to the other end of the slider 10. Therefore, when the rear door 3 moves, the swing arm 20 may rotate with respect to the slider 10 and rectilinearly move along the lower rail 5.

A stopper opposing portion 23 having a bracket shape is formed on one surface of the swing arm 20, such that the motion of the swing arm 20 is restricted by a stopper 40 to be described below. The stopper opposing portion 23 includes a protruding portion 24 that protrudes toward the stopper 40 in order to assuredly restrict the motion of the swing arm 20.

As illustrated in FIG. 3, the stopper 40 is fixedly mounted on the vehicle and provided at one side of the lower rail 5 so as to be in parallel with the lower rail 5. The stopper 40 includes, at one side thereof, a concave portion 44 concavely formed toward the stopper opposing portion 23. The concave portion 44 has a shape corresponding to the shape of the protruding portion 24 and may receive the protruding portion 24.

The lifter 30 includes a cylindrical cylinder 34 rotatably coupled, at one end thereof, to the swing arm 20 and filled with gas, a piston (not illustrated) received in the cylinder 34, and a rod 36 inserted into the cylinder 34 and configured to be movable in a longitudinal direction of the cylinder 34. One end of the rod 36 is coupled to the piston (not illustrated), and the other end of the rod 36 is rotatably coupled to a second mounting bracket 32 fixedly mounted inside the rear door 3.

Here, the first mounting bracket 22 and the second mounting bracket 32 are spaced apart from each other at a predetermined distance and fixedly mounted on the rear door 3, and the swing arm 20 and the lifter 30 are coupled to be rotatable relative to each other, such that when the swing arm 20 rotates, the lifter 30 rotates while maintaining two fixing points (support points) formed on the first and second mounting brackets 22 and 32.

Specifically, when the swing arm 20 rotates toward the outside of the vehicle (counterclockwise based on the swing arm illustrated in FIG. 4), the lifter 30 rotates clockwise about the two fixing points formed on the first and second mounting brackets 22 and 32, and the lifter 30 assumes a posture inclined with respect to the swing arm 20. When the swing arm 20 rotates toward the inside of the vehicle (clockwise based on the swing arm illustrated in FIG. 4) in this state, the lifter 30 rotates counterclockwise about the two fixing points formed on the first and second mounting brackets 22 and 32, and the lifter 30 assumes a posture almost in parallel with the swing arm 20.

When the swing arm 20 rectilinearly moves along the lower rail 5, the lifter 30 connected to the swing arm 20 rectilinearly moves along the swing arm 20.

Meanwhile, the slider 10 according to the exemplary embodiment of the present invention further includes load bearings 12. The load bearings 12 are rotatably coupled to the slider 10 at both sides based on a connecting portion between the slider 10 and the swing arm 20, and the load bearings 12 support the swing arm 20 along a rotation route of the swing arm 20. Therefore, since the slider 10 supports the rear door 3 connected to the swing arm 20, the load bearings 12 disperses a load of the rear door 3 or vertical force applied to the rear door 3 from the outside.

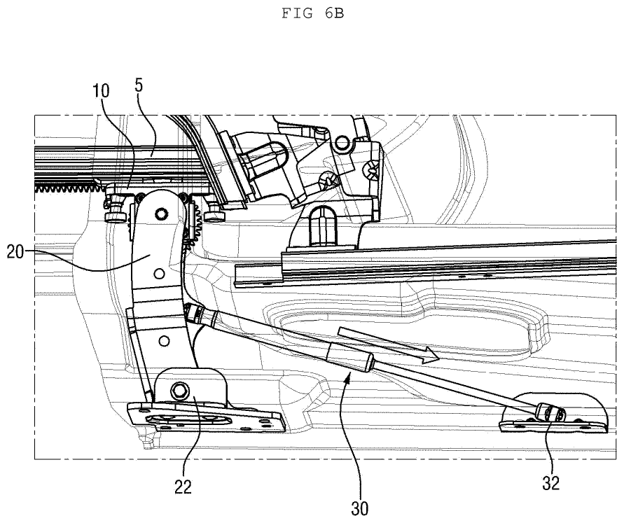

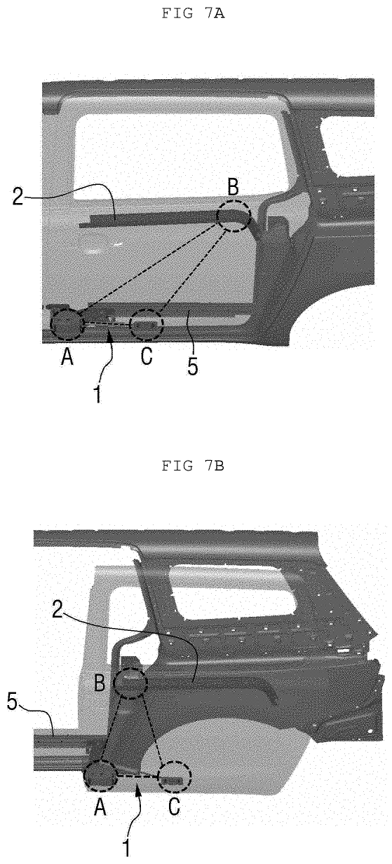

FIG. 6A is a view illustrating a state in which the slider is moved along the lower rail in a direction in which the rear door is closed, FIG. 6B is a view illustrating a state in which the slider is moved along the lower rail in a direction in which the rear door is opened, FIG. 7A is a view illustrating a point at which a load applied to the rear door is supported in the state illustrated in FIG. 6A, and FIG. 7B is a view illustrating a point at which a load applied to the rear door is supported in the state illustrated in FIG. 6B.

Hereinafter, an operating process of the structure 1 for preventing deviation of a sliding door during the process of closing or opening the rear door 3 will be described with reference to FIGS. 6A, 6B, 7A, and 7B.

As illustrated in FIG. 6A, when external force is applied in the direction (left direction in FIG. 6A) in which the opened rear door 3 is closed, the slider 10 connected to the rear door 3 is rectilinearly moved leftward along the lower rail 5, and then the swing arm 20 is rotated at a left end of the lower rail 5. In this case, the rectilinear motion and the rotational motion are stopped as the stopper opposing portion 23 formed on the swing arm 20 meets the stopper 40, and the protruding portion 24 formed on the stopper opposing portion 23 is inserted into the concave portion 44 formed in the stopper 40, such that the motion of the rear door 3 is restricted. As described above, the lifter 30 assumes the posture almost in parallel with the swing arm 20.

In this case, as illustrated in FIG. 7A, the support points, at which the rear door 3 is supported, include two support points A and C formed in the vicinity of the lower rail 5, and a single support point B formed in the vicinity of the center rail 2. Here, the two support points A and C formed in the vicinity of the lower rail 5 are formed by the swing arm 20 and the lifter 30, and the single support point B formed on the center rail 2 is formed by a separate slider (not illustrated) or a separate swing arm (not illustrated) rollably coupled to the center rail 2.

That is, assuming that the support points are in direct contact with the rear door 3 in the exemplary embodiment of the present invention, the two support points A and C formed in the vicinity of the lower rail 5 include the support point A at which the rear door 3 and the swing arm 20 are connected to each other and the support point C at which the rear door 3 and the lifter 30 are connected to each other, and the single support point B formed in the vicinity of the center rail 2 is the support point B at which the rear door 3 and the swing arm (not illustrated) are connected to each other.

Of course, in another exemplary embodiment of the present invention, the support point A may be the support point A at which the lower rail 5 and the slider 10 are connected to each other, and the support point B is the support point at which the slider (not illustrated) and the center rail 2 are connected to each other.

Because three imaginary axes are formed to connect the three support points A, B, and C, the rear door 3 is prevented from rotating in an L direction (width direction of the vehicle body).

Because the load bearings 12 support the rear door 3, the rear door 3 is prevented from rotating in an H direction (vertical direction of the vehicle body).

Meanwhile, as illustrated in FIG. 6B, when external force is applied in the direction (right direction in FIG. 6A) in which the closed rear door 3 is opened, the protruding portion 24 is extended from the concave portion 44, and the slider 10 connected to the rear door 3 rectilinearly moves rightward along the lower rail 5. In this case, the swing arm 20 rectilinearly moves and rotates at the same time, and the slider 10 connected to the swing arm 20 stops rectilinearly moving at the end of the lower rail 5. As described above, the lifter 30 assumes the posture inclined with respect to the swing arm 20.

Here, in a case in which external force is further applied rightward to the rear door 3, the lifter 30 maintains the posture inclined with respect to the swing arm 20 by applying force toward the outside of the vehicle (in the direction of the arrow in FIG. 6B) by using pressure of gas that fills the lifter 30.

In this case, as illustrated in FIG. 7B, since the three support points A, B, and C for supporting the rear door 3 are provided and the inclined posture of the lifter 30 is maintained, the rear door 3 is prevented from rotating in the L direction. The function of the load bearings 12 in this state is identical to the function of the load bearings 12 during the process of closing the rear door 3.

The present invention has been described with reference to the limited exemplary embodiments and the drawings, but the present invention is not limited thereto. The described exemplary embodiments may be variously changed or modified by those skilled in the art to which the present invention pertains within the technical spirit of the present invention and within the scope equivalent to the appended claims.

What is claimed is:

1. A structure to help prevent deviation of a sliding door, the structure comprising:
a lower rail mounted in a longitudinal direction of a vehicle body;
a slider inserted into and rollably coupled to the lower rail;
a swing arm rotatably coupled to the slider and a door of a vehicle; and
a lifter having a first end rotatably coupled to the swing arm and a second end rotatably coupled to the door, the lifter being configured to move along with a rectilinear motion or a rotational motion of the swing arm, wherein one end of the swing arm coupled to the door and the other end of the lifter coupled to the door are spaced apart from each other at a predetermined distance and support the door.

2. The structure of claim 1, wherein one end of the swing arm is rotatably coupled to a first mounting bracket that is fixedly mounted inside the door and the other end of the lifter is rotatably coupled to a second mounting bracket that is fixedly mounted inside the door.

3. The structure of claim 1, wherein the structure is configured so that when the swing arm rotates toward the outside of the vehicle, the lifter rotates to be inclined with respect to the swing arm and applies force toward the outside of the vehicle by using pressure of gas that fills the lifter.

4. The structure of claim 1, further comprising a stopper fixedly mounted on the vehicle and provided at one side of the lower rail and configured to restrict the rectilinear motion or the rotational motion of the swing arm.

5. The structure of claim 4, wherein the swing arm has a protruding portion protruding toward the stopper, and the stopper has a concave portion corresponding to the protruding portion.

6. The structure of claim 1, wherein a load bearing configured to support a load of the door is coupled to the slider coupled to the lower rail.

7. The structure of claim 6, wherein load bearings are formed at both sides based on the slider.

8. The structure of claim 1, further comprising a center rail formed at a middle portion of the door, wherein support points at which the door is supported include two support points formed on the lower rail and a single support point formed on the center rail.

9. A vehicle comprising:
a vehicle body;
a vehicle door;
a lower rail mounted in a longitudinal direction of the vehicle body;
a slider inserted into and rollably coupled to the lower rail;
a swing arm rotatably coupled to the slider and the vehicle door; and
a lifter having a first end rotatably coupled to the swing arm and a second end rotatably coupled to the vehicle door, the lifter being configured to move along with a rectilinear motion or a rotational motion of the swing arm, wherein one end of the swing arm coupled to the vehicle door and the other end of the lifter coupled to the vehicle door are spaced apart from each other at a predetermined distance and support the vehicle door.

10. The vehicle of claim 9, wherein one end of the swing arm is rotatably coupled to a first mounting bracket that is fixedly mounted inside the vehicle door and the other end of the lifter is rotatably coupled to a second mounting bracket that is fixedly mounted inside the vehicle door.

11. The vehicle of claim 9, wherein the vehicle is configured so that when the swing arm rotates toward the outside of the vehicle, the lifter rotates to be inclined with respect to the swing arm and applies force toward the outside of the vehicle by using pressure of gas that fills the lifter.

12. The vehicle of claim 9, further comprising a stopper fixedly mounted on the vehicle body and provided at one side of the lower rail and configured to restrict the rectilinear motion or the rotational motion of the swing arm.

13. The vehicle of claim 12, wherein the swing arm has a protruding portion protruding toward the stopper, and the stopper has a concave portion corresponding to the protruding portion.

14. The vehicle of claim 9, wherein a load bearing configured to support a load of the vehicle door is coupled to the slider coupled to the lower rail.

15. The vehicle of claim 14, wherein load bearings are formed at both sides based on the slider.

16. The vehicle of claim 9, further comprising a center rail formed at a middle portion of the vehicle door, wherein support points at which the vehicle door is supported include two support points formed on the lower rail and a single support point formed on the center rail.
